(19) United States
(12) Patent Application Publication
(10) Pub. No.: US 2025/0275586 A1
(43) Pub. Date: Sep. 4, 2025

(54) AEROSOL-GENERATING SYSTEM

(71) Applicant: NICOVENTURES TRADING LIMITED, London (GB)

(72) Inventors: Nejat ERGUVEN, London (GB); Sean LUKAN, Winston-Salem, NC (US)

(21) Appl. No.: 18/858,927

(22) PCT Filed: Apr. 21, 2023
(86) PCT No.: PCT/GB2023/051058

§ 371 Date: Oct. 22, 2024

(30) Foreign Application Priority Data
Apr. 22, 2022 (GB) 2205858.0

(51) Int. Cl. A24F 40/53; A24F 40/51; A24F 40/65; G06F 21/32

(52) U.S. Cl. CPC A24F 40/53; A24F 40/51; A24F 40/65; G06F 21/32

(57) ABSTRACT

There is provided an aerosol-generating system (100). for providing an aerosol for inhalation by a user, comprising: an aerosol provision device (110) comprising control circuitry (120) for controlling an activation state of the aerosol provision device: a biometric detector (140) arranged to detect a property associated with a user of the aerosol provision device and provide a signal to the control circuitry: and. a material detector (130) arranged to detect a property associated with aerosol generating material (132), in use arranged in the aerosol provision device. and provide a signal to the control circuitry, wherein. in response to receiving a signal originating from the biometric detector and the material detector. the control circuitry is arranged to update an activation state of the aerosol provision device.

### TECHNICAL FIELD

The present invention relates to an aerosol-generating system, an aerosol provision device, a method of providing an aerosol for inhalation by a user, and aerosol-generating means.

### BACKGROUND

Aerosol-generating systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### SUMMARY

Aspects of the invention are defined in the accompanying claims.

In accordance with some embodiments described herein, there is provided an aerosol-generating system, for providing an aerosol for inhalation by a user, comprising: an aerosol provision device comprising control circuitry for controlling an activation state of the aerosol provision device; a biometric detector arranged to detect a property associated with a user of the aerosol provision device and provide a signal to the control circuitry; and, a material detector arranged to detect a property associated with aerosol generating material, in use arranged in the aerosol provision device, and provide a signal to the control circuitry, wherein, in response to receiving a signal originating from the biometric detector and the material detector, the control circuitry is arranged to update an activation state of the aerosol provision device.

Such a system is able to identify the aerosol generating material intended for use with the aerosol provision device, ascertaining if it is an age-restricted aerosol generating material. The system is also able to detect a property of the user, such as an indication of age. The system then updates an activation state of the aerosol provision device using this information. This allows the system to determine if age restricted material is to be used in the device and whether this is appropriate for the user (based on their biometric property). The system is able then to prevent or allow activation of the device. This therefore provides increased in-use safety of the device, preventing inappropriate aged user from use of the device with age-restricted products. This system also allows users to use devices for aerosol generating materials that are not age-restricted.

This therefore strikes a balance between overly strict and overly lenient control over the usage of the aerosol provision device.

In particular, in the event that consumable 1 is supplied for use with the aerosol provision device, consumable 1 containing an age-restricted aerosol generating material, the system recognises the aerosol generating material as being age-restricted. The system then obtains a property of the user. This allows the system to determine the user or the age of the user. The system then ascertains whether the user is of an age suitable for the aerosol generating material in the device. If the user is, the device is allowed to activate. If the user is not, the device may be prevented from activating.

In contrast, when consumable 2 is supplied for use with the aerosol provision device, consumable 2 not containing an age-restricted aerosol generating material, the system obtains an indication of the user. The device may be arranged (pre-programmed by the user for example) such that only the owner of the device may use the device. In this instance, even when a non age-restricted material is provided to the device, the device may not activate if the user is not recognised as an authorised user. Alternatively, based on the user preference, when the system recognises a non age-restricted aerosol generating material, the device can be activated.

In this way, the manufacturer can provide a device that has a broad utility across a number of consumables and users, while protecting the device from being used with aerosol generating material that is unsuitable for a specific user. Furthermore, the user can select a suitable leniency or strictness level in terms of use of the device.

The user experience of the device may also be increased by having a personalisable, “plug-and-play” approach. In that, the user may be provided with a number of options from which to select the operating state that the user desires—which can be chosen based on recognition of the aerosol generating material in the device. In this way, the user need not create, from scratch, an operating state for use with a consumable (containing a specific aerosol generating material), but can refine their preference from a number provided. In this way, the safety of the device is also maintained as each of the possible selectable operating states are known by the manufacturer to provide a suitable aerosol without damaging the device. Therefore, both the device and user benefit from the arrangement. Furthermore, the user may only be able to access some of the operating states following age verification—increasing the overall safety of use of the device.

By using detection of a property associated with aerosol generating material in-use combined with the aerosol provision device for providing an aerosol for inhalation by a user, and detecting a user, the system can provide the user's heating profile (if one is setup by the user). In that, user 1 may prefer heating profile 1 for aerosol generating material 1, while user 2 may prefer heating profile 2 for aerosol generating material 1. In this way, the system provides a bespoke aerosol to a user based on recognition of both the user and the aerosol generating material. This increases the user experience of the system.

Furthermore, if the identification method does not recognise the aerosol generating material (by virtue of it being e.g. a non-authentic or damaged consumable) the device may not be able to operate. In this way, the device can be protected from use with unknown and un-tested consumables (containing unknown and/or un-tested aerosol generating material), or damaged consumables, that might provide a substandard aerosol for the user or damage the device in an attempt to produce an aerosol.

The aerosol provision system of the present invention is able to operate in “offline” or “online” mode when performing age verification of potential users. In this way, a valid user may operate the system in offline (unconnected to a mobile network or internet or the like) environment provided the user satisfies the criteria for operation. The user experience of the device is thereby improved. This can be achieved by including a memory in the aerosol provision system with which the age verification means communicates.

In accordance with some embodiments described herein, there is provided an aerosol provision device, for providing an aerosol for inhalation by a user, comprising: control circuitry for controlling an activation state of the aerosol provision device; a biometric detector arranged to detect a property associated with a user of the aerosol provision device and provide a signal to the control circuitry; and, a material detector arranged to detect a property associated with aerosol generating material, in use arranged in the aerosol provision device, and provide a signal to the control circuitry, wherein, in response to receiving a signal originating from the biometric detector and the material detector, the control circuitry is arranged to update an activation state of the aerosol provision device.

In accordance with some embodiments described herein, there is provided a method of providing an aerosol for inhalation by a user, the method comprising: detecting, by a biometric detector, a property associated with a user of an aerosol provision device; providing, by the biometric detector, a signal to control circuitry of the aerosol provision device; detecting, by a material detector, a property associated with aerosol generating material, in use arranged in the aerosol provision device; providing, by the material detector, a signal to the control circuitry of the aerosol provision device; updating, by the control circuitry, an activation state of the aerosol provision device in response to receiving a signal originating from the biometric detector and the material detector.

In accordance with some embodiments described herein, there is provided aerosol-generating means, for providing an aerosol for inhalation by a user, comprising: an aerosol provision means comprising control means for controlling an activation state of the aerosol provision means; biometric detecting means arranged to detect a property associated with a user of the aerosol provision means and provide a signal to the control means; and, material detecting means arranged to detect a property associated with aerosol generating material, in use arranged in the aerosol provision means, and provide a signal to the control means, wherein, in response to receiving a signal from the biometric detecting means and the material detecting means, the control means is arranged to update an activation state of the aerosol provision means.

### DESCRIPTION OF DRAWINGS

The present teachings will now be described by way of example only with reference to the following figures:

FIG. 1 is a schematic view of an aerosol provision system according to an example;

FIG. 2 is a schematic view of an aerosol provision system according to an example;

FIG. 3 is a schematic view of an aerosol provision system according to an example; and,

FIG. 4 is a schematic view of an aerosol provision system according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein.

25 Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

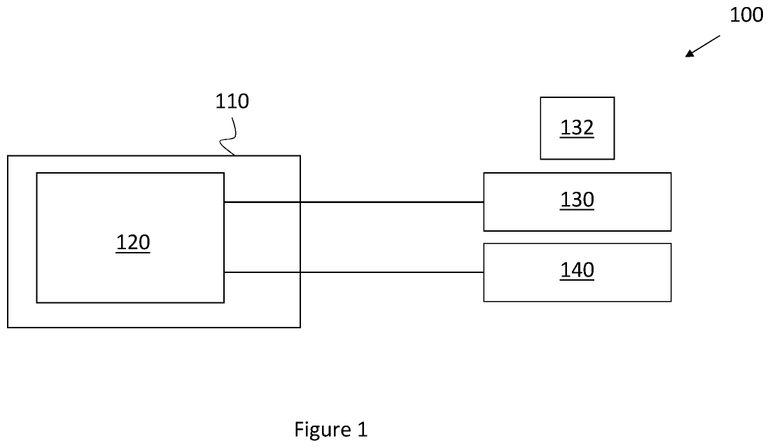

FIG. 1 illustrates a schematic view of an example of an aerosol provision system 100 according to the present invention. The aerosol provision system 100 comprises an aerosol provision device 110. The aerosol provision device 110 has control circuitry 120. The control circuitry 120 is arranged to control an activation state of the aerosol provision device 110. The aerosol provision system 100 comprises a biometric detector 140 arranged to detect a property associated with a user of the aerosol provision device 110 and provide a signal to the control circuitry 120. The aerosol provision system 100 comprises a material detector 130 to detect a property associated with aerosol generating material 132, in-use, arranged in the aerosol provision device 110 and provide a signal to the control circuitry 120. In response to receiving a signal from the biometric detector 140 and the material detector 130, the control circuitry 120 is arranged to update an activation state of the aerosol provision device 110.

In an example, the material detector 130 detects a property of the aerosol generating material 132 to ascertain whether the material 132 is age-restricted in some way. The property of the aerosol generating material 132 may be any of a chemical composition of the aerosol generating material, a strength of the aerosol generating material, a size of the consumable containing the aerosol generating material, a rating of the consumable containing the aerosol generating material, an authenticity of the consumable containing the aerosol generating material; amount; date of production; and, batch number or the like.

In an example, the property associated with a user may be one relating to recognition of a face of a user, a voice of the user, a fingerprint of the user, and an iris of the user. The biometric detector may be at least one of: a face scanner; a fingerprint scanner; an iris scanner; a microphone; a camera; a mobile device; a chemical detector; sphygmomanometer; pulse detector and, a communication module for communicating with a database.

The full range of operating states of the aerosol provision device 110 may be very wide ranging such that the aerosol provision device 110 can be used with a correspondingly wide range of consumables (aerosol generating materials). In this way, the user need not be limited to only certain types of consumable for use with the aerosol provision device 110. However, from within this wide range, some operating states will not be suitable for use with some consumables. As such, it is important to offer states that will provide a desirable aerosol from the consumable. By offering all the possible states to all consumables, the onus would be put onto the user to work out which operating states interact well with which consumables. This may decrease the user experience of the system. As noted above, by recognising the user and the aerosol generating material, a suitable or preferred heating profile may be provided (or a range of suitable heating profiles may be offered). This increases the user experience of the device 110.

The aerosol provision device 110 may comprise heating arrangements or the like for providing an aerosol from a consumable—the consumable may contain some aerosol generating material or the like. The control circuitry 120 may control the heating arrangement (or the like) according to the signal received from the material detector 130 and biometric detector 140. The detectors 130, 140 enable the control circuitry 120 to ascertain whether the user is a suitable user of the aerosol provision device 110 for the aerosol generating material 132 to be used with the aerosol provision device 110. This may relate to appropriateness of the user in terms of age or health or ownership of the device 110.

In an example, the detectors 130, 140 may provide signals to the control circuitry 120, the control circuitry 120 may recognise the signals as belonging to a valid user or an appropriate user for the aerosol generating material 132 and enable any operational mode of the device 110. In another example, the detectors 130, 140 may provide signals to the control circuitry 120, the control circuitry 120 may recognise the signals as belonging to an invalid user or an inappropriate user for the aerosol generating material 132 and prevent any operational mode of the device 110. In this way, protection over the use of the aerosol provision device 110 is provided. This protection is not user intensive; the protection does not rely on the user taking intensive actions to provide the protection, rather the protection is provided for the user based on a recognition of the user and the aerosol generating material 132, increasing the user experience of the device 110 as well as increasing the safety of use of the device 110.

The control circuitry 120 may be arranged to update an activation state of the aerosol provision device 110 to a non-operating state in response to receiving signals from the biometric detector 140 and the material detector 130 associated with a non-authorised user. The same may occur for an inappropriate user considering the aerosol generating material 132 detected.

For example, a sphygmomanometer is a device that is used to detect high blood pressure. If the aerosol generating material 132 is recognised as being particularly high risk for a user with such a condition, the control circuitry 120 may deem the user inappropriate and prevent use of the device 110 with that specific aerosol generating material 132. A chemical detector may detect the cholesterol of the user or the like and act accordingly for aerosol generating material 132 known to exacerbate such issues. In another example, the user may be recognised as being an inappropriate age for an are-restricted aerosol generating material 132, at which point the control circuitry 120 may prevent use of the device 110 with that specific aerosol generating material 132.

The biometric detector 140 may be a communication module arranged to communicate with at least one of: a remote database; a remote computing arrangement; an onboard database; and, an onboard computing arrangement. This assists in providing feedback to the control circuitry 120 from a database, furthermore this assists in providing the data collected in the device 110 for use in the database for other devices. The detector 140 may compare any received signal against a remote or on board database, to confirm the identity (and relevant characteristics) of the user.

The database may be stored in a memory on board the device 110. This memory is on board memory and the database is therefore also on board. This may be advantageous as the device 110 need not have a communications element in the device 110 to communicate with a remotely held database, and the device 110 need not be connected to a communications network to access a remotely held database prior to each use session. The biometric detector 140 may access the database to ascertain the age of the user, the user's identify.

In an example, the device 110 communicates with a database and the database is a look up table of signals (obtained by biometric detectors) and associated age ranges for those signals.

In another example, the device 110 communicates with a computing arrangement and the computing arrangement utilises an artificial intelligence arrangement for assessing age based on the signals received from the control circuitry 120.

Biometric data belonging to the owner of the device 110 may be stored on board so as to enable a rapid approval of the regular user of the device 110. This may be arranged on purchase of the device 110 where the owner can be age assessed by a vendor of the device 110, via presentation of identification or the like. While irregular users may be verified against the database or the computing arrangement via the signals from the biometric detector 140, details regarding the owner of the device 110 may be stored locally.

The material detector 130 may read information from the aerosol generating material 132 or from the consumable in which the aerosol generating material 132 is stored. The material detector 130 is at least one of: QR code reader; bar code reader; infra red detector; and, an RFID reader or arranged to use at least one of Bluetooth TM, Bluetooth Low Energy™, ZigBee™, WiFi™, Wifi Direct™, GSM, 2G, 3G, 4G, 5G, LTE, NFC, or RFID. The aerosol generating material 132 or consumable may have a code or the like on the material or consumable that the material detector 130 is arranged to read prior to use. This may be outside the device 110 or in use within the device 110.

The material detector 130 may detect from the code any relevant details of the aerosol generating material 132, these may include chemical composition, amount, date of production, and batch number. Other communications options may be used to ascertain the relevant aspects of the contents of the aerosol generating material 132. For example, communication via the “Internet of Things”. This can allow health considerations to be made by the device 110 in terms of allowing access to an aerosol formed from the aerosol generating material 132, these considerations can advantageously be made on a user by user basis.

The control circuitry 120 is arranged to update an activation state of the aerosol provision device 110 to an operating state in response to receiving signals from the biometric detector 140 and the material detector 130 associated with an authorised user. Whether a user is authorised user includes considerations for age and health of the user or the like. Each of these are considered against the aerosol generating material 132 and implications of an aerosol produced from the aerosol generating material 132.

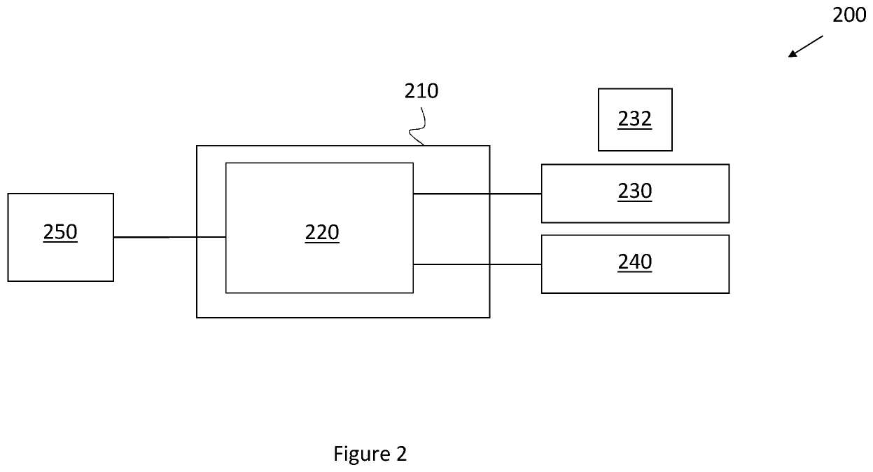

Referring now to FIG. 2, there is a shown a similar system 200 to the system 100 of FIG. 1. Similar features, to those features used in FIG. 1, are shown with the reference numerals increased by 100. For example, the system 100 of FIG. 1 is similar to the system 200 of FIG. 2. Similar or identical features may not be discussed for conciseness.

The system 200 of FIG. 2 has aerosol provision device 210 comprising the control circuitry 220, material detector 230, aerosol generating material 232, and biometric detector 240. The system 200 also has an age verification means 250. The age verification means 250 is located outside of the aerosol provision device 210. The age verification means 250 is for verifying an age of a user. In response to receiving a signal from the biometric detector 240 and the material detector 230, the control circuitry 220 is arranged to at least one of change an activation state of the aerosol provision device, and activate the age verification means 250.

The age verification means 250 may comprise at least one of a face scanner, a fingerprint scanner, an iris scanner, a microphone, a camera, a mobile device, and a communication module for communicating with a database or computing arrangement. Such a device can recognise aspects of a user and associate that with an age or an age range for the user. For example, a camera may recognise aspects such as lines in the face, bags under the eyes, and prevalence of e.g. in males, facial hair to provide an age range for the user. An image may be taken by the camera and compared to data obtained from the specific owner of device 210 to ascertain whether the user is the owner of the device 210. Alternatively, the image could be provided to a database for obtaining a likely age range of the user. This can be used to ascertain whether the user should be provided an aerosol from the age-restricted aerosol generating material 232.

Such factors can be used to indicate a probable age range of the potential user of the device 110. The age verification means 150 may perform an analysis of the data taken of the user, and provide a signal to the control circuitry 120 indicating whether the user is of a likely suitable or likely unsuitable age for use of the device. Alternatively or additionally, the camera may be used to inspect a user's identification, such as a passport to the like, to detect an age of the user. If there is an image on the identification, this can be compared against the user's face using the camera.

In the example of FIG. 2, the material detector 230, biometric detector 240 and age verification means 250 are separate to the device 210. The material detector 230, biometric detector 240 and age verification means 250 may be in three or two devices, or combined into one device separate to the aerosol provision device 210. In a specific example, the material detector 230, biometric detector 240 and age verification means 250 are part of one smart device to be used alongside the aerosol provision device 210.

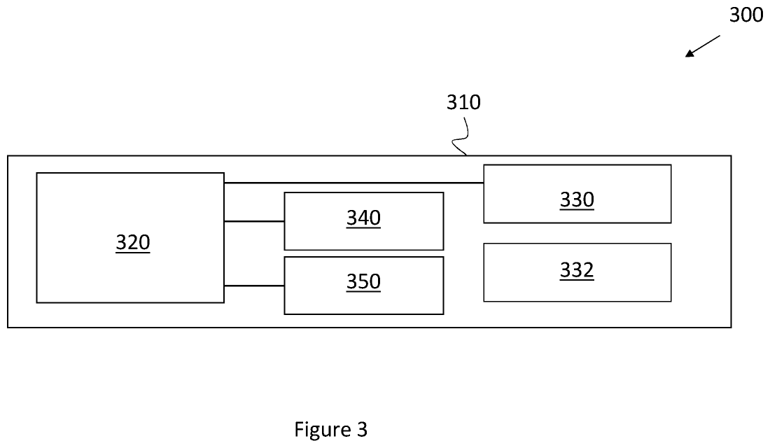

Referring now to FIG. 3, there is a shown a similar system 300 to the system 200 of FIG. 2. Similar features, to those features used in FIG. 2, are shown with the reference numerals increased by 100. For example, the system 200 of FIG. 2 is similar to the system 300 of FIG. 3. Similar or identical features may not be discussed for conciseness.

The system 300 of FIG. 3 has aerosol provision device 310 comprising the control circuitry 320, material detector 330, aerosol generating material 332, and biometric detector 340. The system 300 also has an age verification means 350. The age verification means 350 is located within the aerosol provision device 310. The age verification means 350 is for verifying an age of a user.

The material detector 330, aerosol generating material 332, biometric detector 340, and age verification means 350 are integral with the aerosol provision device 310 in the example of FIG. 3. This provides a compact arrangement that reduces the number of additional items the user carries.

As mentioned above, the control circuitry 320 is arranged to update an activation state of the aerosol provision device 310 to an operating state in response to receipt of a signal from the material detector 330 and biometric detector 340, but that where there material detector 330 indicates an age restricted material, the age verification means 350 may be activated. For example, where the aerosol generating material 332 contains a nicotine value that is negligible or zero, the system 300 is allowed to provide an aerosol to the user without requiring age verification. This may also be applied to other suitable age-restricted compounds.

In the event that the age verification means 350 detects the user is in an age range (or of an age) suitable for using the system 300 in all operational modes (such as heating age restricted aerosol generating material), the control circuitry 320 may allow any such activation of the device 310. In the event that the age verification means 350 detects the user is not in an age range (or of an age) suitable for use with the aerosol generating material 332, the control circuitry 320 may signal to the user that the aerosol generating material 332 is to be removed from the aerosol provision device 310. Notifications to the user may occur via a screen on the aerosol provision device 310 or any other suitable means such as a display on the age verification means 350 (where the age verification means 350 is separate to the device 310).

This arrangement allows suitable handling of a device that is used by multiple users of different age. The users of suitable age are allowed to access suitable operational states for respective aerosol generating materials, while users of un-suitable age are prevented from doing so. This ensures that suitability of use is prioritised alongside user safety.

In an example, the control circuitry 320 is arranged to update an activation state of the aerosol provision device 310 in response to receipt of an access signal or deny signal from the age verification means 350. In response to receipt of an access signal, the control circuitry 320 may update the device 310 to a full access mode where all functions are allowed for the aerosol generating material 332. In response to receipt of a deny signal, the control circuitry 320 may update the device 310 to a no access mode, where all functions are denied or only partial functionality is provided for the aerosol generating material 332.

In an example, the control circuitry 320 is arranged to provide a notification to a user in response to receipt of a deny signal from the age verification means 350. The notification may be in the form of an audible signal, a visual signal, a haptic signal, a textual message or the like displayed on a screen or display or the like. Any suitable notification method may be used, including sending a signal to a personal device of the user, such as a smart device or the like. The age verification means 350 may be a smart device (if not integral with the aerosol provision device 310). The notification may be provided from the age verification means 350.

The present invention involves changing an activation sate of the aerosol provision device. In an “operating state”, elements of the aerosol provision device used to generate an aerosol (such as an atomiser, heater or the like) may be activated. The specific activation of the device may require an additional input which may be inhalation on the device, pressing a button on the device or the like. Alternatively, the device may automatically generate aerosol by a heater in response to receiving a signal associated with a valid potential user. The control circuitry may receive such a signal from the age verification means and send a signal to the heater arrangement or the like to provide an aerosol from an aerosol generating material that may contained within, or separate to, the aerosol provision device.

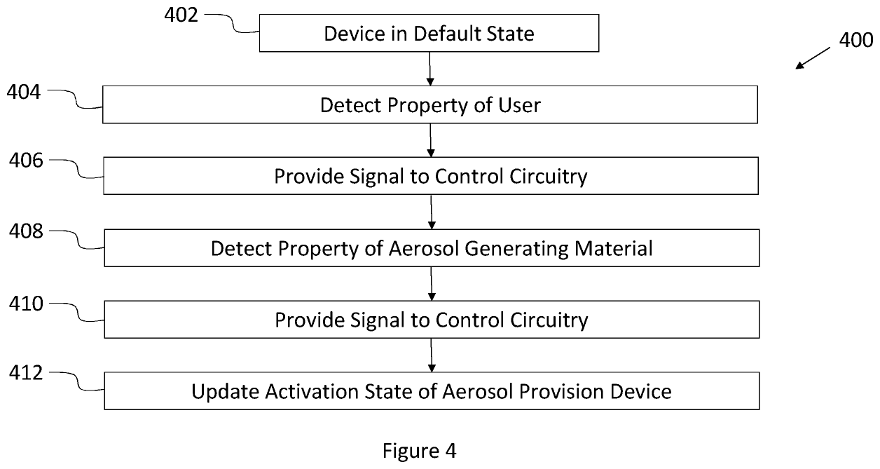

FIG. 4 shows a method 400 of use of an aerosol provision device. In the method 400, the device may start in a default state 402, which may be a non-operating state such that when age restricted aerosol generating material is provided to the device, users cannot use the device without age verification or the detection of no age-restricted aerosol generating material being present.

Alternatively, the default operating state may be a restricted operating state where only partial operation of the device is possible. Alternatively, the device may be an operating mode and is prevented from operating in response to detection of age-restricted aerosol generating material.

When a user intends to use the aerosol provision device, the user inputs the aerosol generating material to the device. The device detects a property of the user 404. The device detects the property using a biometric detector (which may contain a number of individual sensors/detectors as mentioned above). The device then ascertains an age, age range or identification of the user. A single is provided to the control circuitry 406.

The device detects a property of the aerosol generating material 408. The detector may detect the property from a barcode, QR code, label or the like, or may detect the chemical composition of the aerosol generating material directly. The detector sends a signal accordingly to the control circuitry 410.

The activation state of the aerosol provision device is updated 412 based on the combination of information relating to the user and the aerosol generating material. Accordingly, the device can provide security against underage use of the device, or against fraudulent usage of the device. Furthermore, the device can prevent use of the device with aerosol generating material unsuitable for the user for other reasons, such as exacerbating existing health concerns.

An assessment may be made whether formal age verification is required or not. This may occur at the detector or the control circuitry. If age verification is not required, the activation state of the aerosol provision device may be updated, if it is, the age verification means may be activated.

This method provides a user-friendly verification and aerosol generating material check process that does not impede overly use for non age-restricted aerosol generating materials.

The method offers a balance between overly strict and overly lenient access protection for the device and aerosol generating material.

The method and device disclosed herein enable protection over the use of the device without requiring an arduous authorisation process—the process is only as arduous as is required considering the content of the aerosol generating material to be used. This improves the user experience of the device and the safety of general use of the device.

The devices and systems disclosed herein have a biometric detector and a material detector that obtain data from a user and a material intended for use in the aerosol provision device or aerosol provision system. This data may be processed by a number of components able to compare the data against a database (for example) of authorised users and associated materials or the like. This data may be analysed on-board the device by e.g. control circuitry. The control circuitry may analyse the signal and evaluate whether to allow or prevent use of the aerosol provision system or aerosol provision device.

In another example, the data from the biometric detector and the material detector may be sent to a remote database or server for analysis. In such an example, the device or system may have a communications module for communicating with the remote database or server. The signals from the biometric detector and the material detector may be sent to the communications module. The communications module may provide a signal to the remote database or server. The remote database or server may then perform the analysis and provide a signal back to the communications module. The communications module may then provide a signal to the control circuitry. The signal ultimately sent to the control circuitry by the communication module may be one indicating the control circuitry should or should not allow use of the aerosol provision device or aerosol provision system. This allows for more complex analysis to be performed off the device, which may render the aerosol provision devices more cost efficient to produce.

The term “in response to” is used herein to indicate a second event (such as a signal or change of state of an aerosol provision device) that occurs subsequent to a first event. The second event may occur at a later time, after a predetermined time, or immediately after the first event.

The device and system herein are described as comprising several components that enable several advantages. The components may be disclosed as on-board the device or within the system. The components may be distributed and therefore not necessarily be located on-board the device. The functionality of the device can be provided by communicatively connected components, and such communication may be wireless, enabling such distribution. At which point it is reasonable to foresee that a distributed array of components will operate in the manner of the devices and systems disclosed herein. Components of the device or system may be contained in a further device such as a smartphone, computer, or remote server or the like.

In a particular example, the device disclosed herein may operate with a flavour pod which is replaceable in the device—this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol-generating system, for providing an aerosol for inhalation by a user, comprising: an aerosol provision device comprising control circuitry for controlling an activation state of the aerosol provision device; a biometric detector arranged to detect a property associated with a user of the aerosol provision device and provide a signal to the control circuitry; and, a material detector arranged to detect a property associated with aerosol generating material, in use arranged in the aerosol provision device, and provide a signal to the control circuitry, wherein, in response to receiving a signal originating from the biometric detector and the material detector, the control circuitry is arranged to update an activation state of the aerosol provision device.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol-generating system, for providing an aerosol for inhalation by a user, comprising:
an aerosol provision device comprising control circuitry for controlling an activation state of the aerosol provision device;
a biometric detector arranged to detect a property associated with a user of the aerosol provision device and provide a signal to the control circuitry; and,
a material detector arranged to detect a property associated with aerosol generating material, in use arranged in the aerosol provision device, and provide a signal to the control circuitry,
wherein, in response to receiving a signal originating from the biometric detector and the material detector, the control circuitry is arranged to update an activation state of the aerosol provision device.

2. An aerosol-generating system according to claim 1, wherein the control circuitry is arranged to update an activation state of the aerosol provision device to a non-operating state in response to receiving signals from the biometric detector and the material detector associated with a non-authorised user.

3. An aerosol-generating system according to claim 2, wherein the biometric detector is at least one of: a face scanner; a fingerprint scanner; an iris scanner; a microphone; a camera; a mobile device; a chemical detector; sphygmomanometer; pulse detector and, a communication module for communicating with a database.

4. An aerosol-generating system according to claim 1, wherein the material detector is at least one of: QR code reader; bar code reader; infra red detector; and, an RFID reader or arranged to use at least one of Bluetooth™, Bluetooth Low Energy™, ZigBee™, WiFi™, Wifi Direct™, GSM, 2G, 3G, 4G, 5G, LTE, NFC, or RFID.

5. An aerosol-generating system according to claim 1, wherein the control circuitry is arranged to update an activation state of the aerosol provision device to an operating state in response to receiving signals from the biometric detector and the material detector associated with an authorised user.

6. An aerosol-generating system according to claim 1, further comprising age verification means for verifying an age of a user,
wherein, in response to receiving a signal originating from the biometric detector and the material detector, the control circuitry is arranged to at least one of:
change an activation state of the aerosol provision device, and
activate the age verification means.

7. An aerosol-generating system according to claim 6, wherein the age verification means comprises at least one of a face scanner; a fingerprint scanner; an iris scanner; a microphone; a camera; a mobile device; and, a communication module for communicating with a database or computing arrangement.

8. An aerosol-generating system according to claim 6, wherein the age verification means is not integral with the aerosol provision device.

9. An aerosol-generating system according to claim 1, wherein at least one of the biometric detector and the material detector is not integral with the aerosol provision device.

10. An aerosol-generating system according to claim 1, further comprising a communications module arranged to:
receive signals from the biometric detector and the material detector;
send signals to a server or remote database; and,
send signals received from the server or remote database to the control circuitry.

11. An aerosol provision device, for providing an aerosol for inhalation by a user, comprising:
control circuitry for controlling an activation state of the aerosol provision device;
a biometric detector arranged to detect a property associated with a user of the aerosol provision device and provide a signal to the control circuitry; and, a material detector arranged to detect a property associated with aerosol generating material, in use arranged in the aerosol provision device, and provide a signal to the control circuitry,
wherein, in response to receiving a signal originating from the biometric detector and the material detector, the control circuitry is arranged to update an activation state of the aerosol provision device.

12. An aerosol provision device according to claim 11, wherein the control circuitry is arranged to update an activation state of the aerosol provision device to a non-operating state in response to receiving signals from the biometric detector and the material detector associated with a non-authorised user.

13. An aerosol provision device according to claim 11, wherein the biometric detector is at least one of: a face scanner; a fingerprint scanner; an iris scanner; a microphone; a camera; a mobile device; a chemical detector; pulse detector and, a communication module for communicating with a database.

14. An aerosol provision device according to claim 11, wherein the material detector is at least one of: QR code reader; bar code reader; infra red detector; and, an RFID reader or arranged to use at least one of Bluetooth™, Bluetooth Low Energy™, ZigBee™, WiFi™, Wifi Direct™, GSM, 2G, 3G, 4G, 5G, LTE, NFC, or RFID.

15-17. (canceled)

18. An aerosol provision device according to claim 11, further comprising a communications module arranged to:
receive signals from the biometric detector and the material detector;
send signals to a server or remote database; and,
send signals received from the server or remote database to the control circuitry.

19. A method of providing an aerosol for inhalation by a user, the method comprising:
detecting, by a biometric detector, a property associated with a user of an aerosol provision device;
providing, by the biometric detector, a signal to control circuitry of the aerosol provision device;
detecting, by a material detector, a property associated with aerosol generating material, in use arranged in the aerosol provision device;
providing, by the material detector, a signal to the control circuitry of the aerosol provision device;
updating, by the control circuitry, an activation state of the aerosol provision device in response to receiving a signal originating from the biometric detector and the material detector.

20. The method of claim 19, wherein updating, by the control circuitry, an activation state of the aerosol provision device comprises updating an activation state of the aerosol provision device to a non-operating state in response to receiving signals from the biometric detector and the material detector associated with a non-authorised user.

21. The method of claim 19, further comprising updating an activation state of the aerosol provision device to an operating state in response to receiving signals from the biometric detector and the material detector associated with an authorised user.

22. The method of claim 19, wherein providing, by the biometric detector, a signal to control circuitry of the aerosol provision device comprises at least one of:
providing, by the biometric detector, a signal direct to the control circuitry of the aerosol provision device; and,
providing, by the biometric detector, a signal to a communication module and subsequently sending a signal from the communication module to the control circuitry.

23. The method of claim 19, wherein providing, by the material detector, a signal to the control circuitry of the aerosol provision device comprises at least one of:
providing, by the material detector, a signal direct to the control circuitry of the aerosol provision device; and,
providing, by the material detector, a signal to a communication module and subsequently sending a signal from the communication module to the control circuitry.

24. (canceled)
